(19) United States
(12) Patent Application Publication
(10) Pub. No.: US 2006/0289795 A1
(43) Pub. Date: Dec. 28, 2006

(54) VACUUM REACTION CHAMBER WITH X-LAMP HEATER

(76) Inventors: Dale R. Dubois, Los Gatos, CA (US); Juan Carlos Rocha-Alvarez, Sunnyvale, CA (US); Amir Al-Bayati, San Jose, CA (US); Khaled A. Elsheref, San Jose, CA (US); Alexandros T. Demos, Fremont, CA (US); Lester A. D'Cruz, San Jose, CA (US); Hichem M'Saad, Santa Clara, CA (US); Ashish Shah, Santa Clara, CA (US); Takashi Shimizu, Kawasaki-shi (JP); Naoyuki Iwasaki, Narita-shi (JP)

Correspondence Address: PATTERSON & SHERIDAN, LLP, 3040 POST OAK BOULEVARD, SUITE 1500, HOUSTON, TX, 77056, US

(21) Appl. No.: 11/383,383

(22) Filed: May 15, 2006

Related U.S. Application Data
(63) Continuation-in-part of application No. 11/143,270, filed on Jun. 2, 2005.
(60) Provisional application No. 60/717,386, filed on Sep. 15, 2005.
(60) Provisional application No. 60/781,908, filed on Mar. 13, 2006.

(51) Int. Cl. G21G 5/00

(52) U.S. Cl. 250/492.1

(57) ABSTRACT

Methods and apparatus for electron beam treatment of a substrate are provided. An electron beam apparatus that includes a vacuum chamber, at least one thermocouple assembly in communication with the vacuum chamber; and a heating device in communication with the vacuum chamber and combinations thereof are provided. In one embodiment, the vacuum chamber comprises a cathode, an anode, and a substrate support. In another embodiment, the vacuum chamber comprises a grid located between the anode and the substrate support. In one embodiment the heating device comprises a first parallel light array and a second light array positioned such that the first parallel light array and the second light array intersect. In one embodiment the thermocouple assembly comprises a temperature sensor made of aluminum nitride.

### CROSS-REFERENCE TO RELATED APPLICATIONS

This application is a continuation-in-part of co-pending U.S. patent application Ser. No. 11/143,270 (APPM/009914), filed Jun. 2, 2005. This application also claims benefit of U.S. provisional patent application Ser. No. 60/717,386 (APPM/010221L), filed Sep. 15, 2005; and benefit of U.S. provisional patent application Ser. No. 60/781,908 (APPM/010221L02), filed Mar. 13, 2006. Each of the aforementioned related patent applications is herein incorporated by reference.

### BACKGROUND OF THE INVENTION

1. Field of the Invention

Embodiments of the present invention generally relate to the fabrication of integrated circuits. More particularly, embodiments of the present invention relate to an apparatus and method for electron beam treatment of a substrate.

2. Description of the Related Art

Integrated circuit geometries have dramatically decreased in size since such devices were first introduced several decades ago. Since then, integrated circuits have generally followed the two year/half-size rule (often called Moore's Law), which means that the number of devices on a chip doubles every two years. Today's fabrication facilities are routinely producing devices having 0.13 μm and even 0.1 μm feature sizes, and tomorrow's facilities soon will be producing devices having even smaller feature sizes.

The continued reduction in device geometries has generated a demand for films having lower dielectric constant (k) values because the capacitive coupling between adjacent metal lines must be reduced to further reduce the size of devices on integrated circuits. In particular, insulators having low dielectric constants, less than about 4.0, are desirable. Examples of insulators having low dielectric constants include spin-on glass, fluorine-doped silicon glass (FSG), and polytetrafluoroethylene (PTFE), which are all commercially available.

More recently, organosilicon films having k values less than about 3.5 have been developed. One method that has been used to develop low dielectric constant organosilicon films has been to deposit the films from a gas mixture comprising one or more organosilicon compounds and then post-treat the deposited films to remove volatile or thermally labile species, such as organic groups, from the deposited films. The removal of the volatile or thermally labile species from the deposited films creates voids in the films, which lowers the dielectric constant of the films, as air has a dielectric constant of approximately 1.

Electron beam treatment has been successfully used to post-treat the deposited films and create voids in the films, while also improving the mechanical properties of the films. However, current electron beam chamber designs suffer from several major drawbacks. First, current electron beam chamber designs can have negative side effects on a substrate, such as damage or destruction of semiconductor devices on a substrate. For example, high gate oxide leakage and voltage threshold (V_{T}) shift have been observed after electron beam treatment. It is believed that the electron beam treatment damages substrates by causing an excess negative charge build up on the substrates from the electrons bombarding the substrate. The excess negative charge build up during device manufacturing can create charge currents that form undesirable current paths in areas of the substrate that are normally insulating, and leakage current through the newly created current paths during operation of the devices can destroy the devices on the substrate. Second, current electron beam chamber designs have contributed to heavy metal contamination of wafers. Third, poor within wafer shrinkage due to a lack of temperature uniformity across the wafer surface has been exhibited. Shrinkage uniformity is an indication of film properties such as hardness.

Thus there remains a need for an improved apparatus and method of electron beam treatment of a deposited layer on a substrate.

### SUMMARY OF THE INVENTION

Accordingly, the present invention provides an apparatus and method that solves the aforementioned problems.

Embodiments of the invention provide an electron beam apparatus for processing a substrate. In one embodiment, the electron beam apparatus for processing a substrate comprises a vacuum chamber, at least one thermocouple assembly in communication with the vacuum chamber, and a cross lamp heating device in communication with the vacuum chamber. In one aspect, the vacuum chamber may further provide a cathode, an anode, and a substrate support. In another aspect, the vacuum chamber comprises a grid located between the anode and the substrate support. In another aspect the vacuum chamber further comprises a plasma flood gun connected to the vacuum chamber, wherein the plasma flood gun is adapted to introduce low energy positive ions into the vacuum chamber. In another aspect the thermocouple assembly comprises a resilient member made of ceramic material. In another aspect the ceramic material is selected for a group consisting of silicon carbide, silicon nitride, aluminum nitride, synthetic diamond and combinations thereof.

In another embodiment, an apparatus for processing a substrate is provided. The apparatus comprises a tubular member with a first end and a second end, the first end having an opening and a temperature sensor disposed in the opening, wherein the temperature sensor comprises a resilient member attached to a surface made of a ceramic material wherein the surface made of ceramic material extends through the opening to provide a substrate contact surface. In one aspect the ceramic material is selected from the group consisting of silicon carbide, silicon nitride, aluminum nitride, synthetic diamond, and derivatives or combinations thereof. In another aspect the apparatus comprises a vacuum chamber and a heating device in communication with the vacuum chamber. In another aspect the vacuum chamber comprises a cathode, an anode, and a substrate support. In another aspect the heating device comprises an outer heating zone having cross lamps and an inner heating zone having parallel lamps. In another aspect, the temperature sensor and the heating device are in electronic communication with a controller configured to control the amount of heat emitted by the heating device. In another aspect, the outer heating zone has a circular light array that crosses the parallel lamps.

In another embodiment an apparatus for processing a substrate comprising a tublular member with a first end and a second end is provided. The first end has an opening and a temperature sensor disposed in the opening. The temperature sensor has a resilient member attached to a surface made of a ceramic material. The surface made of a ceramic material extends through the opening to provide a substrate contact surface.

In another embodiment, the present invention comprises an apparatus for processing a substrate. The apparatus has a thermocouple tip having at least a first portion of a conductor. The thermocouple tip comprises a tubular member with a first end and a second end, the first end having an opening with a temperature sensor disposed in the opening. The temperature sensor comprises a resilient member attached to a surface made of a ceramic material. The surface made of ceramic material extends through the opening. The apparatus also has a connector having at least a second portion of the conductor, and a length of cable comprising an insulator and at least a third portion of the conductor coupling at least the first portion of the conductor with at least the second portion of the conductor.

Further embodiments include an apparatus for processing a substrate comprising a vacuum chamber, a cathode, an anode and a thermocouple. The thermocouple comprising a thermocouple tip having at least a first portion of a conductor wherein the thermocouple tip comprises a tubular member with a first end and second end, the first end having an opening with a temperature sensor disposed in the opening. The temperature sensor comprises a resilient member and a surface made of a ceramic material wherein the surface made of ceramic material extends throught the opening. The thermocouple assembly also has a connector having at least a second portion of a conductor. The thermocouple assembly futher comprises a length of cable comprising an insulator and at least a third portion of the conductor coupling at least the first portion of the conductor with the second portion of the conductor, the insulator encasing at least a portion of the conductor and a bushing disposed around the length of cable.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a cross-sectional view of an electron beam apparatus according to an embodiment of the invention.

FIG. 2 is a graph showing substrate charge current vs. substrate bias voltage during an electron beam treatment according to an embodiment of the invention.

FIG. 3 is a graph showing substrate charge current vs. substrate bias voltage during an electron beam treatment according to another embodiment of the invention.

FIG. 4 is a cross-sectional view of an electron beam apparatus according to another embodiment of the invention.

FIG. 5 is a cross-sectional view of an electron beam apparatus according to another embodiment of the invention.

FIG. 6 is a cross-sectional diagram of an electron beam apparatus according to another embodiment of the invention.

FIG. 7 is a perspective view of one embodiment of a thermocouple assembly.

FIG. 8 is a perspective view of one embodiment of a thermocouple tip shown in FIG. 7.

FIG. 9 is a cross sectional view of the exemplary thermocouple assembly of FIG. 7 taken along line 9-9 on FIG. 7.

FIG. 10A is a schematic view of the thermocouple tip upon initially contacting a substrate.

FIG. 10B is a schematic view of the thermocouple tip after contacting the substrate.

FIG. 11 is a perspective view of one embodiment of a heating device.

FIG. 12A shows shrinkage uniformity for a 300 mm substrate using an old heater design.

FIG. 12B shows shrinkage uniformity for a 300 mm substrate using the heater design of one embodiment of the current invention.

FIG. 13 is a perspective view of another embodiment of a heating design.

FIG. 14 is a perspective view of another embodiment of a heating design.

### DETAILED DESCRIPTION

Embodiments of the invention provide methods and apparatus for reducing charging damage to a substrate during electron beam treatment, reducing wafer contamination, and reducing wafer shrinkage. Generally, the methods and apparatus described herein increase the concentration of positive ions near the substrate during electron beam treatment and allow for greater temperature control across the surface of the wafer while reducing wafer contamination. The method and apparatus herein further provide an improved method and apparatus for temperature control.

Substrates that may be treated according to embodiments of the invention include silicon or silicon-containing substrates, patterned substrates, such as substrates having semiconductor devices thereon, and unpatterned or bare substrates. In one aspect, the substrate comprises a low dielectric constant film that is preferably post-treated with an electron beam to remove volatile species, thus forming pores and lowering the dielectric constant of the film. The low dielectric constant film may be deposited from a mixture comprising an organosilicon compound, a hydrocarbon compound, an optional oxidizer, and/or combinations thereof.

The Electron Beam Apparatus:

In one embodiment, a negative substrate bias is applied during the electron beam treatment to reduce or eliminate charging damage to the substrate during electron beam treatment. By applying a negative substrate bias, positive ions are accelerated towards the substrate. The positive ions neutralize the negative charges that may accumulate on the substrate during electron beam treatment and cause undesirable current paths during manufacturing of devices on the substrate.

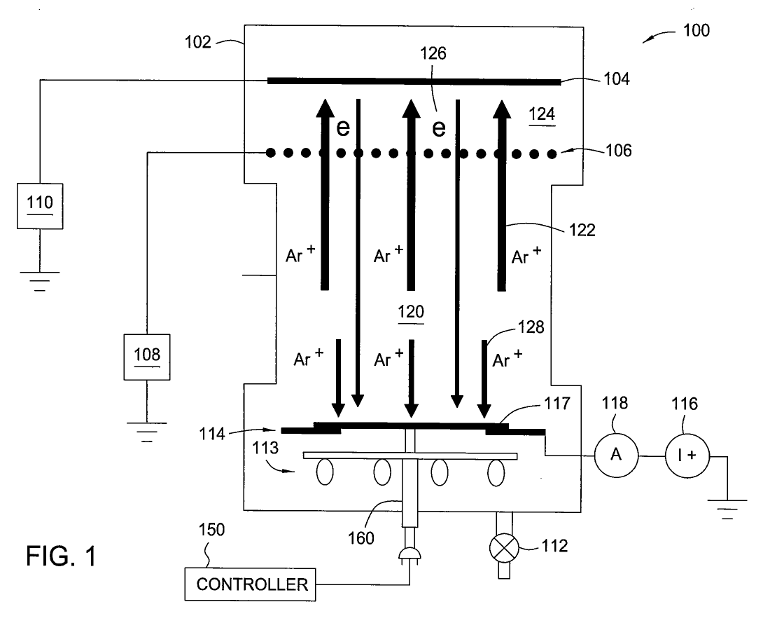

FIG. 1 is a cross-sectional view of an electron beam apparatus 100 that may be used for practicing embodiments of the invention. The electron beam apparatus 100 includes a chamber 102 having a cathode 104 and an anode 106 disposed therein. The anode may be perforated, such as a grid anode. The cathode 104 and the anode 106 are electrically isolated by an insulator (not shown) therebetween. The cathode 104 is connected to a variable high voltage power supply 108 outside of the chamber 102. The anode 106 is connected to a variable low voltage power supply 110 outside of the chamber 102. The chamber 102 also includes a variable rate leak valve 112 for controlling the pressure inside the chamber 102. The chamber may further include a heater 113, e.g., one or more lamps, such as halogen lamps, for heating a substrate during electron beam treatment. The heater 113 is arranged for single sided heating with the heater 113 positioned below the substrate 117. In one embodiment, the heater 113 is placed above the substrate. In one embodiment, the heater 113 is separated from the substrate 117 by a window (not shown). The window may be made of quartz. In one embodiment, the heater 114 is located outside of the vacuum chamber 102 allowing for easy removal and replacement of the heater 113 without impacting the vacuum integrity. The heater 113 will be described in further detail below. A substrate support 114 in the chamber is connected to a substrate bias source 116 that supplies a substrate bias to a substrate 117 supported on the substrate support 114. The substrate bias source 116 may be a variable DC bias source or a variable RF bias source. The apparatus 100 may also include a current meter 118, e.g., an ammeter, to measure the charge flow on a substrate supported on the substrate support 114. The current meter 118 may be located outside of the chamber 102 between the substrate bias source 116 and the substrate support 114. The substrate support 114 may contain at least one hole that extends through the vacuum chamber 120, for embedding a temperature measuring element such as a thermocouple assembly 160. The thermocouple assembly 160 contacts the substrate 117. The thermocouple assembly 160 is connected to a controller 150. In one embodiment more than one thermocouple is included in the vacuum chamber 120. In another embodiment the thermocouple assembly 160 functions as a substrate support.

In operation, according to an embodiment of the invention, a substrate is placed on the substrate support 114 in the vacuum chamber 102. The substrate support 114 is electrically isolated from ground. The chamber is then pumped down from atmospheric pressure to a pressure between about 1 mTorr and about 100 mTorr. A variable rate leak valve 112 is used in controlling the pressure.

The electron beam is typically generated at a high voltage, which is applied to the cathode 104 by the high voltage power supply 108. The high voltage may be between about −500 V to about 30,000 V, or higher. The variable low voltage power supply 110 applies a voltage to the anode 106 that is positive relative to the voltage applied to the cathode 104.

To initiate electron emission in the apparatus, gas in ionization region 120 between the anode 106 and the substrate support 114 must be ionized. The gas may include one or more of argon, helium, nitrogen, hydrogen, oxygen, ammonia, neon, krypton, and xenon, for example. In one embodiment, the gas includes argon. The ionization may be initiated by naturally occurring gamma rays or by a high voltage spark in the chamber 102. Following the initial ionization, the anode 106 is biased with a slightly negative voltage, e.g., between about 0 V and about −250 V to attract positive ions 122, e.g., argon ions, to the anode 106. The positive ions 122 pass into an accelerating field region 124 disposed between the cathode 104 and the anode 106 and are accelerated towards the cathode 104 as a result of the high voltage (e.g., form about −500 V to about 30,000 V applied to the cathode). Upon striking the cathode 104, the positive ions produce secondary electrons 126 that are accelerated back towards the anode 106. While some of the electrons strike the anode, many of the electrons continue on through the anode 106 to contact the substrate 117 on the substrate support 114.

An excess negative charge accumulation on the substrate 117 from the electrons 126 contacting the substrate is prevented by providing a negative bias to the substrate 117 during the electron beam treatment. The negative bias is provided to the substrate 117 by bias source 116 that is connected to the substrate support 114. The bias applied to the substrate may be a DC bias. Alternatively, the bias may be a RF bias, such as for applications involving electron beam treatment of SOI (silicon on insulator) substrates. The negative bias on the substrate 117 attracts some of the positive ions 128, e.g., positive argon ions, in the chamber and accelerates the positive ions 128 towards the substrate 117, resulting in a partial or total neutralization of the negative charges on the substrate 117. The remaining charge on the substrate may induce a charge current on the substrate of less than about 0.005 mA, such as less than about 0.002 mA, e.g., between about 0.001 mA and about 0.002 mA. In one embodiment, the remaining charge current on the substrate is 0 mA or about 0 mA. Without a substrate bias, the substrate charge current is generally approximately equivalent to the electron beam current, which is typically between about 0.5 mA and about 50 mA. Preferably, the negative bias on the substrate 117 is between about −10 and about −30 V, such as between about −20 and about −23 V. However, the optimal substrate bias, which results in a substrate charge current of 0 mA, may vary depending on the electron beam conditions used to treat the substrate.

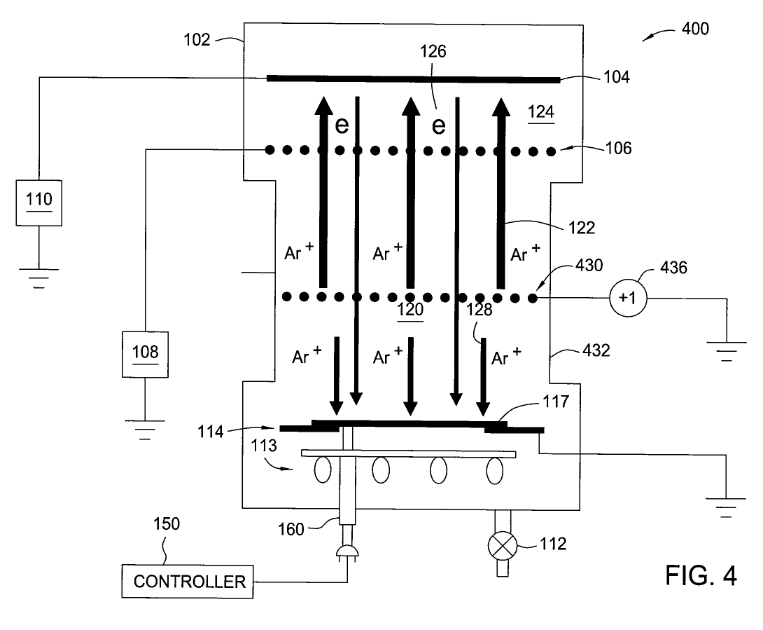

Exemplary electron beam conditions that may be used include a chamber temperature of between about −200° C. and about 600° C., e.g. about 350° C. to about 400° C. The electron beam energy may be from about 0.5 keV to about 30 keV. The exposure dose may be between about 1 μC/cm² and about 400 μC/cm². The chamber pressure may be between about 1 mTorr and about 100 mTorr. The electron beam current may be between about 0.5 mA and about 50 mA. The electron beam conditions provided herein may be used with the apparatus of FIG. 1 as well as the apparatus of FIGS. 4, 5, and 6. The electron beam conditions may also be used with other apparatus.

FIG. 4 is a cross-sectional view of another electron beam apparatus 400 that may be used for practicing embodiments of the invention. Components that are identical to the components of the electron beam apparatus of FIG. 1 are labeled with the same reference numbers. Unlike apparatus 100 of FIG. 1, the substrate support 114 of FIG. 4 is not connected to a substrate bias source. While the substrate support 114 of FIG. 4 is shown as a ring as in FIG. 1, a substrate in the apparatus 400 of FIG. 4 may actually be supported on three contact points that extend from the substrate support 114. One of the three contact points may be a thermocouple assembly 160. Although only one thermocouple assembly 160 is shown, the three contact points may comprise two or more thermocouple assemblies. The thermocouple assembly 160 is connected to a controller 150. In one embodiment more than one thermocouple assembly is included in the vacuum chamber 102. Supporting the substrate on a three point plane helps provide good temperature control of the substrate, as the substrate in uniform contact with its supporting surface. Other embodiments may include any number of contact points comprising thermocouples and/or grounded pins.

The apparatus 400 of FIG. 4 also includes a grid 430 between the anode 106 and the substrate support 114. The grid is attached to the sidewalls 432 of the chamber and is grounded. The grid 430 may have the same dimensions, such as circumference, as the anode 106 or cathode 104. The grid 430 comprises a conductive wire, such as aluminum, that has openings that provide a mesh structure to the grid 430. The openings may be square and have dimensions of several mm by several mm, such as 10 mm×10 mm. In one embodiment, the grid is formed of an aluminum wire having a diameter of 10 mils and 66% transparency. The grid 430 is connected to a bias source 436 that supplies a positive voltage to the grid 430. The bias source 436 may be a RF bias source or a DC bias source.

Electron emission in the apparatus 400 is initiated and maintained as described above with respect to apparatus 100 of FIG. 1. Briefly, the positive ions 122, e.g., argon ions, strike the cathode 104 and provide secondary electrons that contact and treat the substrate 117. A negative field extending from the anode 106 accelerates the electrons towards the substrate 117, which can cause an excess negative charge accumulation on the substrate. While there are positive ions in the chamber 102 that can neutralize the excess negative charge, the negative field extending from the anode 106 also causes the positive ions to accumulate towards the anode 106 rather than towards the substrate 117, where they could neutralize the charges on the substrate 117. By applying a positive bias voltage to the grid 430, the effect of the negative field that extends from the anode 106 is terminated at the grid 430. Thus, the effect of a force, i.e., the anode's negative field, that was previously preventing positive ions from reaching the substrate and neutralizing negative charges on the substrate 117, may be minimized by the grid 430. Also, the positive grid bias pushes positive ions away from the grid 430 and towards the substrate 117 where the positive ions can neutralize the negative charges on the substrate 117. The remaining charge on the substrate 117 may induce a charge current on the substrate 117 of less than about 0.005 mA, such as less than about 0.002 mA, e.g., between about 0.001 mA and about 0.002 mA. In one embodiment, the remaining charge current on the substrate 117 is 0 mA or about 0 mA.

The positive bias voltage that is applied to the grid 430 during the electron beam treatment of a substrate is provided at conditions sufficient to fully or partially neutralize the electron beam charge on the substrate. In one embodiment, the positive bias applied to the grid 430 is between about 3 V and about 30 V. However, it is recognized that the optimal grid bias voltage, which results in a substrate current charge of 0 mA, may vary depending on the electron beam conditions used to treat the substrate. For example, a higher grid bias voltage is required as the energy of the electron beam treatment is increased. The optimal grid bias voltage may also vary depending on the electrical field properties of the substrate itself, such as the substrate's tendency to accumulate negative charge.

Upon performing electron beam treatments of a substrate using a chamber according to FIG. 4, it was found that a grid bias voltage of between about 3 V and about 12 V was sufficient to neutralize the electron beam charge on substrates treated with an electron beam energy of between 2 and 4 keV. A grid bias voltage of about 3 V was sufficient to neutralize the electron beam charge on substrates treated with an electron beam current between 1 mA and 4 mA at 2 keV and 400° C. Thus, it was found that the grid bias voltage required to neutralize the electron beam charge may not change over a range of electron beam currents.

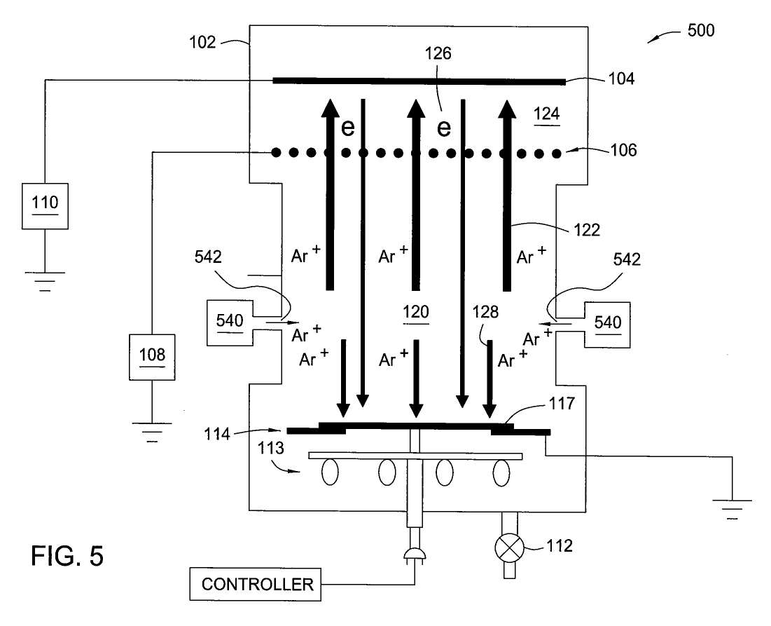

FIG. 5 is a cross-sectional view of another electron beam apparatus 500 that may be used for practicing embodiments of the invention. The apparatus 500 is similar to the apparatus 100 shown in FIG. 1 with the exceptions that the substrate support 114 of apparatus 500 is not connected to a substrate bias source, and the apparatus 500 further includes a plasma flood gun 540. The plasma flood gun 540 may be connected to the side of the chamber 102 to introduce low energy ions, i.e., ions having an energy of less than about 5 eV, such as low energy Ar ions, through an inlet 542 in the side of the chamber 102. The plasma flood gun 540 and inlet 542 may be positioned between the anode 106 and the substrate support 114 such that the positive ions provided to the chamber by the plasma flood gun 540 are provided near the substrate support 114 to locally increase the concentration of positive ions near the substrate 117 on the substrate support 114, and thus neutralize the electron beam charge on the substrate 117. The plasma flood gun 540 also provides electrons to the chamber 102, and thus, an excess positive charge accumulation on the substrate 117 is prevented.

While FIGS. 1, 4, and 5 have been shown and described as providing three separate solutions for neutralizing the electron beam charge on the substrate, any combination of the methods and apparatus described herein with respect to FIGS. 1, 4, and 5 may be used to reduce charging damage to a substrate during electron beam treatment. For example, a substrate may be treated with an electron beam in a chamber having both a positively biased grid between the anode and the substrate support and a plasma flood gun that provides low energy positive ions to the chamber during the electron beam treatment. Preferably, the plasma flood gun introduces the low energy positive ions into the chamber between the grid and the substrate support. Also, a substrate may be treated with an electron beam in a chamber having both a positively biased grid between the anode and the substrate support and a substrate bias source that supplies a negative bias to the substrate during the electron beam treatment.

### EXAMPLES

The following examples illustrate embodiments of the invention. The substrates in the examples were 300 mm substrates that were treated in an EBk™ electron beam chamber available from Applied Materials, Inc. of Santa Clara, Calif.

### Example 1

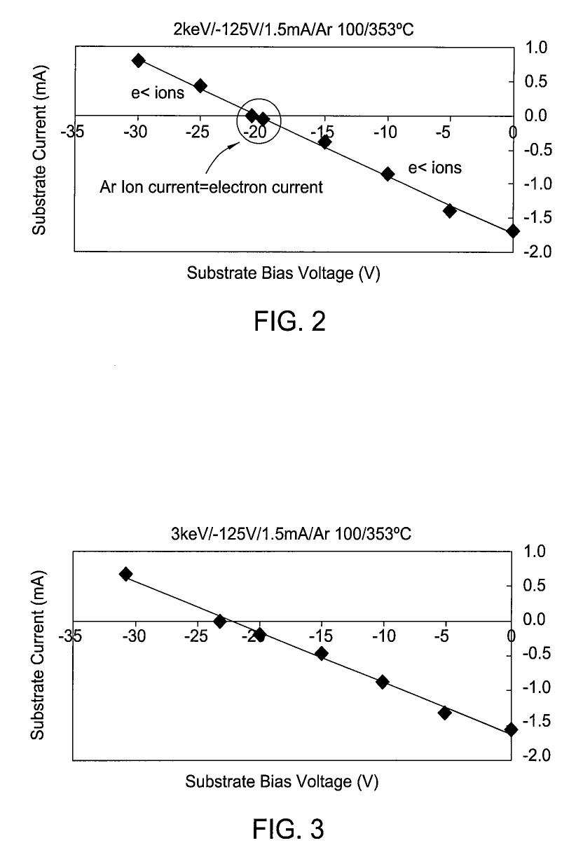

A bare silicon substrate was electron beam treated under the following conditions: an electron beam energy of 2 keV, an anode voltage of −125 V, an electron beam current of 1.5 mA, an argon flow of 100 sccm, and a substrate temperature of 353° C. The charge current on the substrate was measured at different substrate DC bias voltages. FIG. 2 is a graph showing the charge current on the substrate at different substrate DC bias voltages.

### Example 2

A bare silicon substrate was electron beam treated under the following conditions: an electron beam energy of 3 keV, an anode voltage of −125 V, an electron beam current of 1.5 mA, an argon flow of 100 sccm, and a substrate temperature of 353° C. The charge current on the substrate was measured at different substrate DC bias voltages. FIG. 3 is a graph showing the charge current on the substrate at different substrate DC bias voltages.

FIG. 2 shows that a substrate charge current of 0 mA or about 0 mA was obtained when a substrate bias voltage of approximately −20 V was applied to the substrate during an electron beam treatment having an energy of 2 keV. FIG. 3 shows that a substrate charge current of 0 mA or about 0 mA was obtained when a substrate bias voltage of approximately −23 V was applied to the substrate during an electron beam treatment having an energy of 3 keV. Thus, FIGS. 2 and 3 illustrate that embodiments of the invention provide a method of producing a substrate charge current of about 0 mA during electron beam treatment and thus provide a method of reducing charging damage that may occur due to excess negative charge accumulation on substrates during electron beam treatment. A substrate charge current of about 0 mA indicates that the positive ion current at the substrate is substantially equal to the electron current at the substrate.

While the results described above with respect to Examples 1 and 2 were obtained using bare silicon substrates, similar results, i.e., a substrate charge current of approximately 0 mA at a substrate bias of −20 V, were obtained with patterned substrates containing semiconductor devices. It was also observed that applying negative bias to the substrate did not significantly affect the energy of the electron beam treatment. For example, using a 2 keV electron beam treatment and substrate bias of −20 V, a final electron beam energy of 1.98 keV was observed, illustrating that the substrate bias did not substantially reduce the electron beam energy.

It is also believed that applying a substrate bias as described herein may enhance sealing of pores that are located near the substrate surface and are created during electron beam treatment of substrates having low dielectric constant films thereon, as the substrate bias provides a very low energy ion bombardment to substrates.

### Example 3

Silicon substrates having a film of Black Diamond IIx (process conditions available from Applied Materials, Inc. of Santa Clara, Calif.) deposited thereon were electron beam treated in an apparatus as shown in FIG. 4 under the following conditions: an electron beam energy of 3.3 keV, an anode voltage of −125 V, an electron beam current of 1.5 mA, an argon flow of 100 sccm, and a substrate temperature of 400° C. The grounded aluminum wire grid of the apparatus had 66% transparency, a wire diameter of 10 mils, and 0.011 inch diameter openings. The charge current on the substrates was measured at different grid bias voltages. The charge current on the substrates increased as the grid bias voltage was increased and reached 0 at a grid bias voltage of 25 V. The properties, including thickness, refractive index, shrinkage, thickness uniformity, dielectric constant, and stress, of the Black Diamond IIx films after the electron beam treatments were comparable to the properties of Black Diamond IIx films that were electron beam treated under similar conditions in a chamber that did not include a grid that was positively biased as shown and described with respect to FIG. 4.

The Thermocouple:

Embodiments of the present invention also provide a thermocouple assembly comprising a ceramic tip. Although primarily discussed with processing chamber 600, the thermocouple assembly 160 may also be used with the aforementioned chambers as well as other processing chambers including but not limited to CVD, PVD, PECVD or any other processing or manufacturing chambers requiring temperature monitoring.

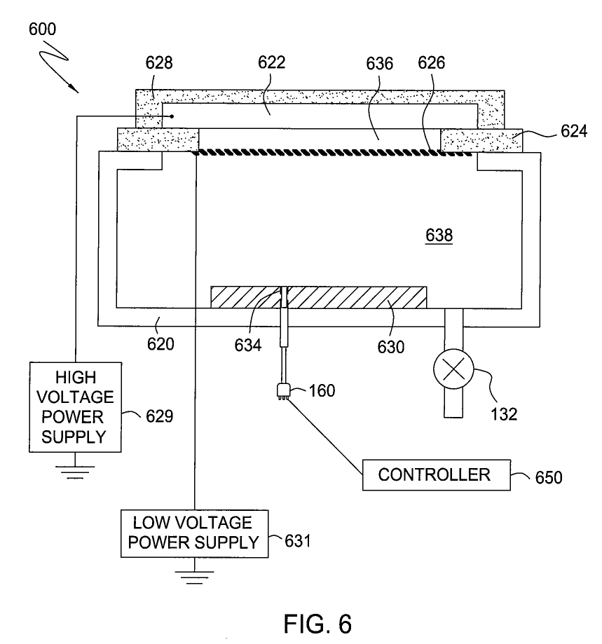

FIG. 6 is a cross-sectional diagram of an exemplary processing chamber 600, the e-beam chamber, in accordance with an embodiment of the invention. The e-beam chamber 600 includes a vacuum chamber 620, a large-area cathode 622, a target plane or substrate support 630 located in a field-free region 638, and a grid anode 626 positioned between the target plane 630 and the large-area cathode 622. The target plane 630 contains at least one hole 634 that extends through the vacuum chamber 620, for embedding a temperature measuring element such as a thermocouple assembly 160. The thermocouple assembly 160 is connected to a controller 150. The e-beam chamber 600 further includes a high voltage insulator 624 and an accelerating field region 636 which isolates the grid anode 626 from the large-area cathode 622, a cathode cover insulator 628 located outside the vacuum chamber 620, a variable leak valve 632 for controlling the pressure inside the vacuum chamber 620, a variable high voltage power supply 629 connected to the large-area cathode 622, and a variable low voltage power supply 631 connected to the grid anode 626.

Other details of the e-beam chamber 600 are described in U.S. Pat. No. 5,003,178, entitled “Large-Area Uniform Electron Source,” issued Mar. 26, 1991, and herein incorporated by reference to the extent not inconsistent with the invention.

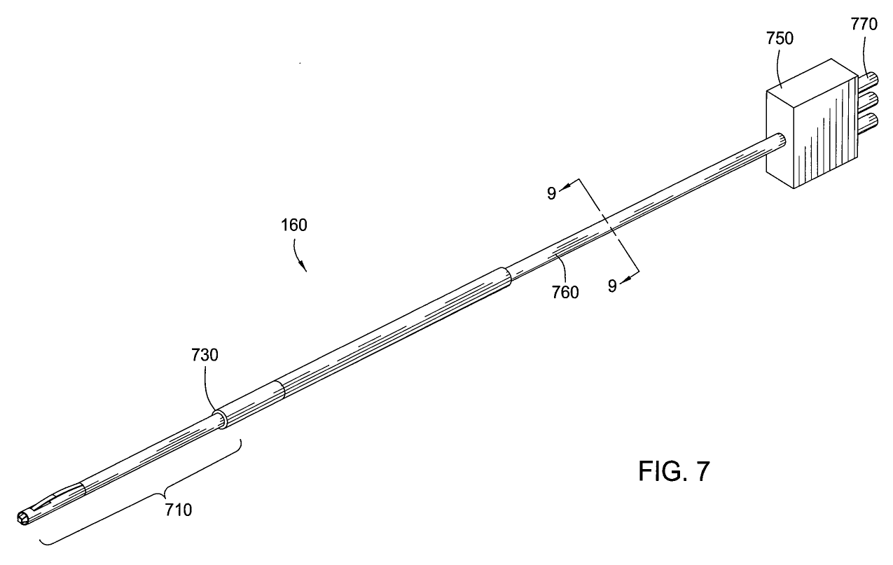

FIG. 7 is a perspective view of one embodiment of the thermocouple assembly 160. The thermocouple assembly 160 of this embodiment comprises a thermocouple tip 710 coupled to a bushing 730. The thermocouple tip 710 and tapered bushing 730 are attached via a length of cable or cable segment 720 (see FIG. 9) to a backshell 750 via a protective tube 760 surrounding the cable segment 720. The backshell 750 houses a plurality of bent contacts (not shown), each coupled both to a conductor 710 of the thermocouple assembly 160 (e.g. by welding) and to a corresponding pin (not shown) of a connector 770.

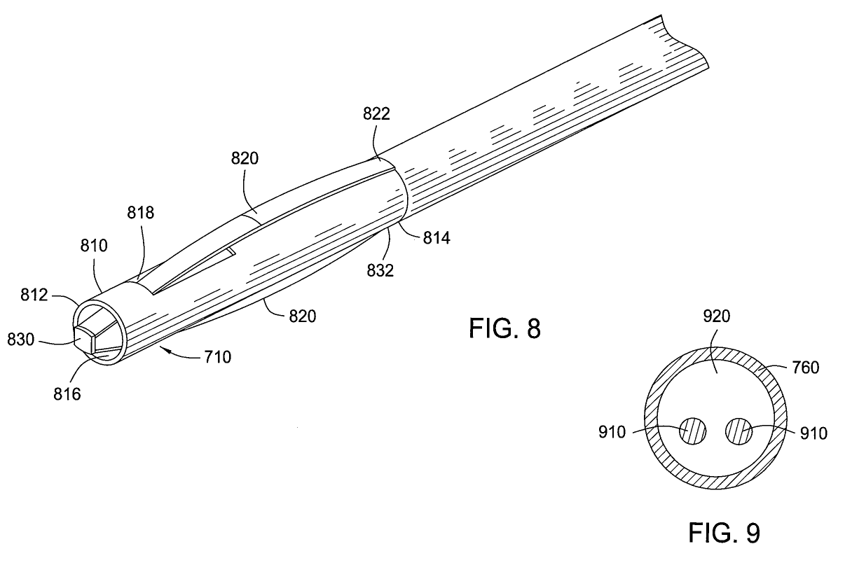

FIG. 8 is a perspective view of one embodiment of the thermocouple tip 710 shown in FIG. 7. The thermocouple tip 710 comprises a tubular member 810 with a first end 812 and a second end 814. The tubular member 810 has an opening 816 and a pair of slots 818 formed on the surface of the tubular member 810 through each of which passes a resilient member 820 with two ends 822 and 832. The ends 822 and 832 of the resilient member 820 are attached to the outer surface of the tubular member 810 at the second end 814 by brazing or other attachment methods known in the art. A contact surface 830 is attached to the resilient member 820 by brazing or other common attachment methods known in the art. The resilient member 820 is biased so that the contact surface 830 protrudes out of the opening 816 of the first end 812 of the tubular member 810. A conductor 810 comprising two wires, shown in FIG. 9, is attached to the inner side of the contact surface 830 by brazing or other common attachment methods known in the art, thus forming a thermocouple junction or temperature sensor.

The contact surface 830 can be any shape but preferably has a low mass with a smooth surface. The contact surface 830 is preferably made of a ceramic material selected from the group consisting of silicon carbide, silicon nitride, aluminum nitride, synthetic diamond and derivatives thereof. Other materials possessing fast response time and excellent thermal conductivity that do not react with process chemistries are also acceptable. The choice between these materials is process dependent.

The resilient member 820 is preferably a spring loaded device like a leaf spring, compression spring, flat spring, or conical spring but can also be any resilient or bendable wire providing the desired characteristics. The resilient member 820 is of such length and shape so that in both the resilient member's 820 compressed and uncompressed state the resilient member 820 extends past the opening 816 of the first end 812 of the tubular member 810. Full contact between the thermocouple junction and the substrate surface is assured by the over travel allowance of the thermocouple tip 710. Further, full contact with the substrate surface is assured by the gimbal action of the thermocouple tip 710. The resilient member 820 comprises any suitable spring type material such as aluminum, stainless steel (e.g. INCONEL®) and other high strength, corrosion resistant metal alloys that do not react with process chemistries.

FIG. 9 is a cross sectional view of the exemplary thermocouple assembly 160 of FIG. 7 taken along line 9-9. FIG. 9 shows the cable segment 920 enclosed within the protective tube 760. The cable segment 920 comprises insulated cable which has sufficient flexibility to resist breakage when the entire thermocouple assembly 160 is fixed at either end but stiff enough to allow the cable segment 920 to be inserted into the protective tube 760. The cable segment 920 comprises at least one conductor 910 insulated with a highly compressed refractory mineral insulation enclosed in a liquid-tight and gas-tight continuous protective tube 760. The protective tube 760 comprises any suitable material such as aluminum, stainless steel (e.g. INCONEL®) and other high strength, corrosion resistant metal alloys that do not react with process chemistries.

The conductor 910 is attached by brazing or other attachment methods known in the art to the opposite surface of the contact surface 830 to form the thermocouple junction attached to the resilient member 820. If the conductor 910 is soldered to the contact surface 830, care must be taken to use a minimal amount of solder because a large mass of solder will decrease the rate of response by conducting heat away from the junction and will also interfere with the proper flexure of the resilient member 820.

The thermocouple is inserted into the hole 634 of the e-beam chamber 600 of FIG. 6 such that the tapered bushing 730 of the thermocouple assembly 160 mates against a tapered stop (not shown) formed within the hole 634 of the e-beam chamber 600, and the contact surface 830 extends beyond the hole 634 and is disposed in the vacuum chamber. The tapered bushing 730 and the stop, when mated together, form a stop mechanism that secures the thermocouple assembly 160 to the e-beam chamber 600, stops the thermocouple assembly 160 when proper contact between the substrate surface (not shown) and the thermocouple contact surface 830 are achieved and also forms a seal. The stop mechanism also makes the thermocouple assembly 160 easily removable. Tapered surfaces are used in the stop mechanism to allow easy disengagement of the thermocouple assembly 160. Those skilled in the art should recognize that the tapered bushing 730 and stop do not necessarily have to be tapered and may be of any shape and size adapted to mate with one another.

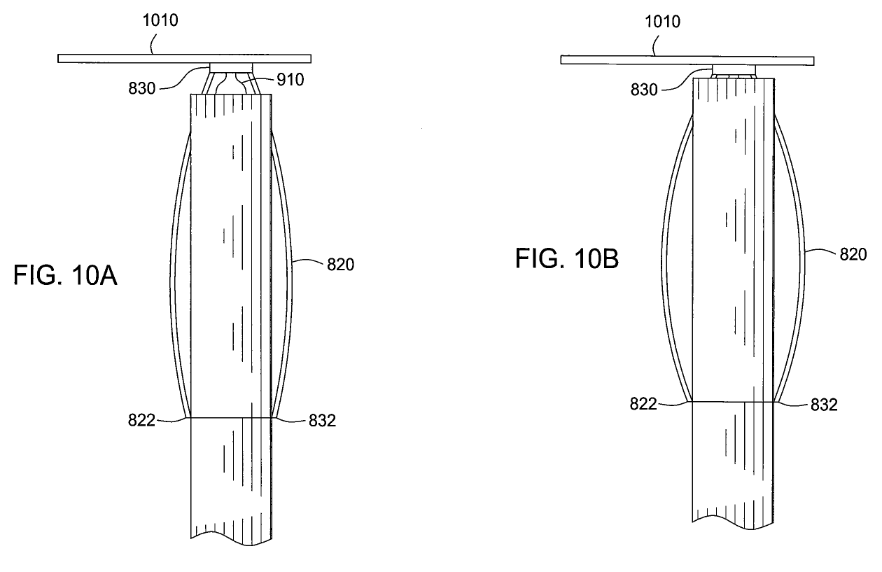

In operation, the substrate with the low dielectric constant film thereon to be exposed with the electron beam is placed on the target plane 630. FIG. 10A is a schematic view of the contact surface 830 and resilient member 820 of the thermocouple tip 710 upon initially contacting a substrate surface 1010. The resilient member 820 is in an unbiased position. As shown in FIG. 10B, when the substrate surface 1010 makes contact with the contact surface 830 of the thermocouple tip 710, the downward force provided by the weight of the substrate surface 1010 biases the resilient member 820. The biasing of the resilient member 820 allows the contact surface 830 to maintain contact with the substrate surface 1010 while also allowing the substrate to contact the target plane 630.

During processing, a voltage is developed between the two wires of the conductor attached at the thermocouple junction and the unattached end of the wires or reference junction which is maintained at a known temperature. The difference in temperature between the thermocouple junction and the reference junction generates an electromotive force that is proportional to the temperature difference. This measured voltage is transmitted through the conductor 910 to the controller 150 and used to determine the temperature of the substrate.

Aspects of the processing chamber 600 are operated by a control system. The control system may include any number of controllers, such as controller 150, processors and input/output devices. In one embodiment, the control system is a component of a closed loop feedback system which monitors various parameters within the process chamber 600 while processing a substrate, and then issues one or more control signals to make necessary adjustments according to various setpoints. In general, the parameters being monitored include temperature, pressure, and gas flow rates.

The X Lamp Heater:

Embodiments of the present invention also provide a heating device or heater 113; preferably, the heater 113 is a cross lamp heating assembly. Although discussed with reference to electron beam chambers, the heater 113 may also be used with other processing chambers including but not limited to CVD, PVD, PECVD chambers.

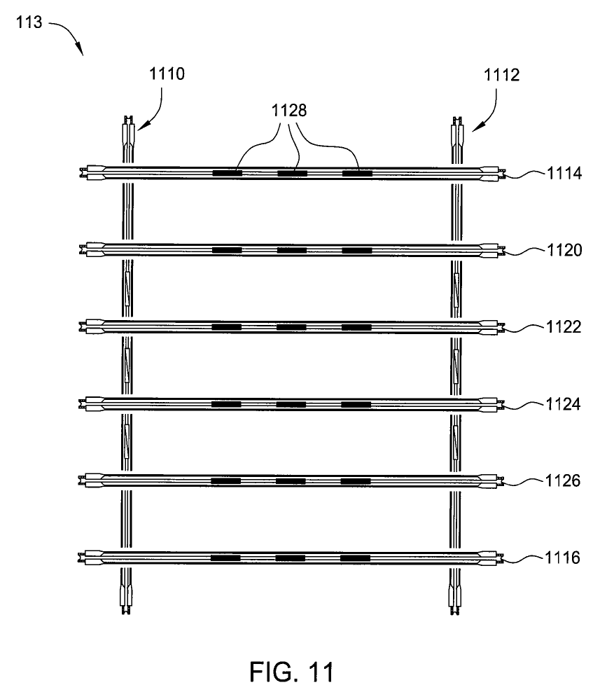

FIG. 11 is a perspective view of one embodiment of a heating device 113. The heating device 113 is preferably a cross-lamp heating device. In the illustrative embodiment, the heating device 113 may comprise one or more lamps, including but not limited to halogen lamps, halogen-tungsten lamps or high-powered arc lamps. The heating device can 113 be configured to produce between one and three temperature control zones. In one embodiment where the heating device 113 has two temperature control zones, the heating device 113 has an outer zone comprising four lamps 1110, 1112, 1114, and 1116 in a crossed configuration. The heating device 113 also has an inner zone comprising four lamps 1120, 1122, 1124, 1126 in a parallel configuration. The lamps may be arranged in any desired geometry but it is preferred that at least two of the lamps cross within at least one temperature zone, and that the lamp configuration provides a minimum of two temperature zones. In one embodiment, each zone can be between 1 and 100 kilowatts, more preferably, each zone is about 3 kilowatts for a total of 6 kilowatts. In one embodiment, the filaments 1128 of the lamps in each zone have the same length. In another embodiment, the lamps in each zone have different filament profiles to better define the temperature profile and uniformity. The refractor (not shown) separating the two zones is part of the main housing thereby increasing rigidity and cooling of the reflector (not shown). In one embodiment, the lamp electrical connectors (not shown) are spring loaded. The linear lamps themselves are a spec lamp which conforms to the user's power, voltage and filament specifications. Both connector and lamp are on the inside of a quartz tube which is exposed to atmosphere thereby eliminating any arcing, allowing for natural convective cooling and eliminating the lamp as a source of contamination.

If needed, the wafer pin lift mechanism (not shown) can be modified by changing the slide/servo units to a motor wrap version for packaging clearance along with changing the wafer pin lift to quartz to eliminate shadowing. If converting between 200 and 300 mm wafers a SiC coated graphite preheat ring (not shown) can be used to convert between 200 mm and 300 mm wafers. The preheat ring eliminates wafer edge loss by running at a higher temperature.

To verify the lamp module design, Lamp Irradiance Simulation was performed. The modeling demonstrated both the inner and outer zone irradiance patterns and was also able to verify the patterns controllability. Changing inner and outer zone power settings demonstrated the capability of producing a flat, concave or convex irradiation pattern along with a smooth transition between zones.

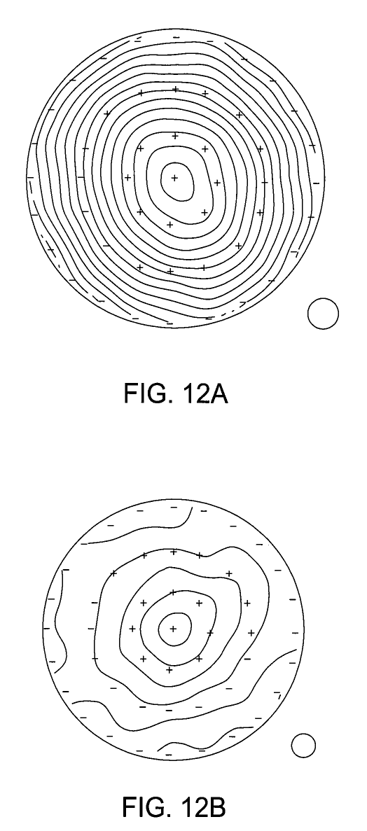

FIG. 12A shows shrinkage uniformity for a 300 mm substrate using an old heater design. The original EBk™ lamp module at 400° C. set point was only capable of a range no better than 20° C. across a 300 mm substrate. This resulted in shrinkage uniformity values (3σ) of 26% on a 1500 Å low-k film as shown in FIG. 12A.

FIG. 12B shows shrinkage uniformity for a 300 mm substrate using the heater design of the current invention. Using the heater design of the current invention the temperature range across a 300 mm substrate was brought down to 7° C. at a 400° C. set point. This resulted in shrinkage uniformity values (3σ) of 8% on a 1500 Å low-k film as shown in FIG. 12B.

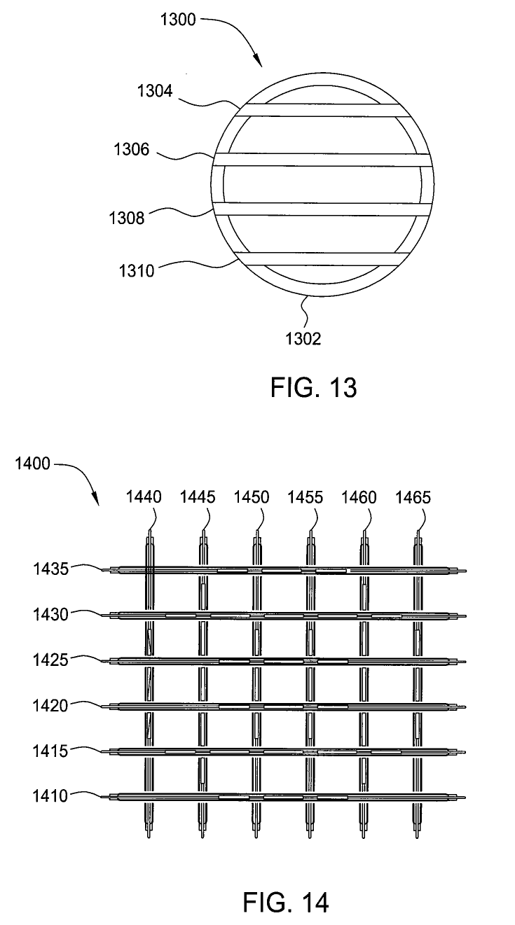

FIG. 13 is a perspective view of another illustrative embodiment of a heating device 1300 that may be used with the current invention. The heating device 1300 may also be used with other processing chambers including but not limited to CVD, PVD, and PECVD chambers. The heating device 1300 has an outer zone comprising a ring or circular lamp 1302. The heating device 1300 also has an inner zone comprising four lamps 1304, 1306, 1308, and 1310 in a parallel configuration. Those skilled in the art will recognize that other configurations and geometries are possible.

FIG. 14 is a perspective view of another embodiment of a heating device 1400 that may be used with the current invention. The heating device 1400 has three temperature control zones. The first zone comprises lamps 1410, 1435, 1440, and 1465. The second zone comprises 1415, 1430, 1445, and 1460. The third zone comprises 1420, 1425, 1450, and 1455. The first zone has a filament length of approximately 152 mm for a 300 mm substrate. The second zone has a filament length of approximately 279 mm for a 300 mm substrate. The third zone has a filament length of approximately 152 mm for a 300 mm substrate. These filament lengths are illustrative and other filament lengths may be used to produce the desired temperature profile.

While the foregoing is directed to embodiments of the present invention, other and further embodiments of the invention may be devised without departing from the basic scope thereof, and the scope thereof is determined by the claims that follow.

1. An electron beam apparatus for processing a substrate comprising:
a vacuum chamber;
at least one thermocouple assembly in communication with the vacuum chamber; and
a cross lamp heating device in communication with the vacuum chamber.

2. The electron beam apparatus of claim 1, wherein the vacuum chamber comprises:
a cathode;
an anode; and
a substrate support.

3. The electron beam apparatus of claim 2, wherein the vacuum chamber further comprises a substrate bias source connected to the substrate support.

4. The electron beam apparatus of claim 2, wherein the vacuum chamber further comprises a grid located between the anode and the substrate support.

5. The electron beam apparatus of claim 1, wherein the vacuum chamber further comprises a plasma flood gun connected to the vacuum chamber, wherein the plasma flood gun is adapted to introduce low energy positive ions into the vacuum chamber.

6. The electron beam apparatus of claim 1, wherein the thermocouple assembly comprises a resilient member made of a ceramic material.

7. The electron beam apparatus of claim 6, wherein the ceramic material is selected from a group consisting of silicon carbide, silicon nitride, aluminum nitride, synthetic diamond and combinations thereof.

8. The electron beam apparatus of claim 1, wherein the at least one thermocouple assembly comprises a temperature sensor made of aluminum nitride.

9. The electron beam apparatus of claim 8, wherein the at least one thermocouple assembly functions as a substrate support.

10. The electron beam apparatus of claim 1, wherein the at least one thermocouple assembly and the cross lamp heating device are in electronic communication with a controller configured to control the amount of heat emitted by the cross lamp heating device.

11. The electron beam apparatus of claim 1, wherein the cross lamp heating device comprises two or more parallel arrays positioned such that the first parallel array intersects the second parallel array.

12. The electron beam apparatus of claim 1, wherein the cross lamp heating device comprises an inner zone and an outer zone configured to emit different amounts of heat.

13. The electron beam apparatus of claim 1, wherein the cross lamp heating device is located below the substrate.

14. An apparatus for processing a substrate comprising:
a tubular member with a first end and a second end, the first end having an opening; and
a temperature sensor disposed in the opening, wherein the temperature sensor comprises a resilient member attached to a surface made of a ceramic material wherein the surface made of the ceramic material extends through the opening to provide a substrate contact surface.

15. The apparatus of claim 14, wherein the ceramic material is selected from the group consisting of silicon carbide, silicon nitride, aluminum nitride, synthetic diamond, and derivatives thereof.

16. The apparatus of claim 14 further comprising:
a vacuum chamber; and
a heating device in communication with the vacuum chamber.

17. The apparatus of claim 16, wherein the heating device comprises an outer heating zone having cross lamps and an inner heating zone having parallel lamps.

18. The apparatus of claim 17, wherein the temperature sensor and the heating device are in electronic communication with a controller configured to control the amount of heat emitted by the heating device.

19. The apparatus of claim 18, wherein the outer heating zone has a circular light array that crosses the parallel lamps.

20. An electron beam apparatus for processing a substrate comprising:
a vacuum chamber comprising:
a cathode;
an anode; and
a substrate support;
a thermocouple assembly in communication with the vacuum chamber; and
a grid located between the anode and the substrate support, wherein the grid is connected to a bias source.
